(19) United States
(12) Patent Application Publication
(10) Pub. No.: US 2006/0060612 A1
(43) Pub. Date: Mar. 23, 2006

(54) Liquid media flapper dispensing valve

(76) Inventor: Keith Antal, Valatie, NY (US)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/946,695

(22) Filed: Sep. 22, 2004

(51) Int. Cl. G01F 11/00; B67D 5/42

(52) U.S. Cl. 222/386

(57) ABSTRACT

A container for storing and dispensing a liquid media. The container includes an end cap that is attached to a container body. The end cap includes at least one valve orifice disposed through the end cap. The at least one valve orifice includes a cut-out in the end cap and a flap attached to the end cap. The flap includes a preloaded hinge attached to the end cap. When the flap is in a first position, it is in contact with an edge adjacent the respective orifice cut-out. When pressure is exerted on the liquid media, the flap is displaced to a second position enabling flow of the liquid media through the cut-out.

### FIELD OF THE INVENTION

The invention relates to a container used to dispense a liquid media and, more specifically, to an end cap employed on a container that dispenses liquid or slurried product, such as condiments and sauces.

### BACKGROUND OF THE INVENTION

Sauces, pastes or liquid media historically have been dispensed from packages that typically have a hole or slit opening which produces poor repeatability, inaccurate flow, and unsanitary conditions. With these dispensers, the liquid product will drool (i.e., unwanted material drips or oozes out of the dispenser). The drooling causes a mess, causes waste, and allows exposure of the liquid product such that it can be easily contaminated.

### SUMMARY OF THE INVENTION

The present invention relates to a container for storing and dispensing a liquid or slurry (generally referred to herein as “liquid”). The container includes an end cap attached to a container body. The end cap includes at least one valve orifice disposed through the end cap. The at least one valve orifice includes a cut-out and a flap attached to the end cap. The flap can be integrally formed with the end cap. The flap includes a preloaded hinge attached to the end cap at an outboard edge of the flap. The hinge can be integrally formed with the end cap and can be at location other than the outboard edge of the flap. When the flap is in a first position, it is in contact with an edge adjacent the respective orifice cut-out. When pressure is exerted on the liquid, the flap is displaced to a second position enabling flow of the liquid media through the cut-out.

### BRIEF DESCRIPTION OF THE DRAWINGS

For purposes of illustrating the invention, there is shown in the drawings various forms that are presently preferred; it being understood, however, that this invention is not limited to the precise arrangements and constructions particularly shown.

FIG. 1 is a perspective view illustrating a liquid dispensing container according to the present invention.

FIG. 2 is a cross section view taken along line 2-2 of FIG. 1 illustrating an end cap of the present invention.

FIG. 3 is an enlarged side sectional view taken along line 3-3 of FIG. 1 illustrating a valve orifice of the present invention.

FIG. 4 is an enlarged side sectional view of the valve orifice of FIG. 3 wherein the orifice is opened by liquid media flow.

### DETAILED DESCRIPTION OF THE DRAWINGS

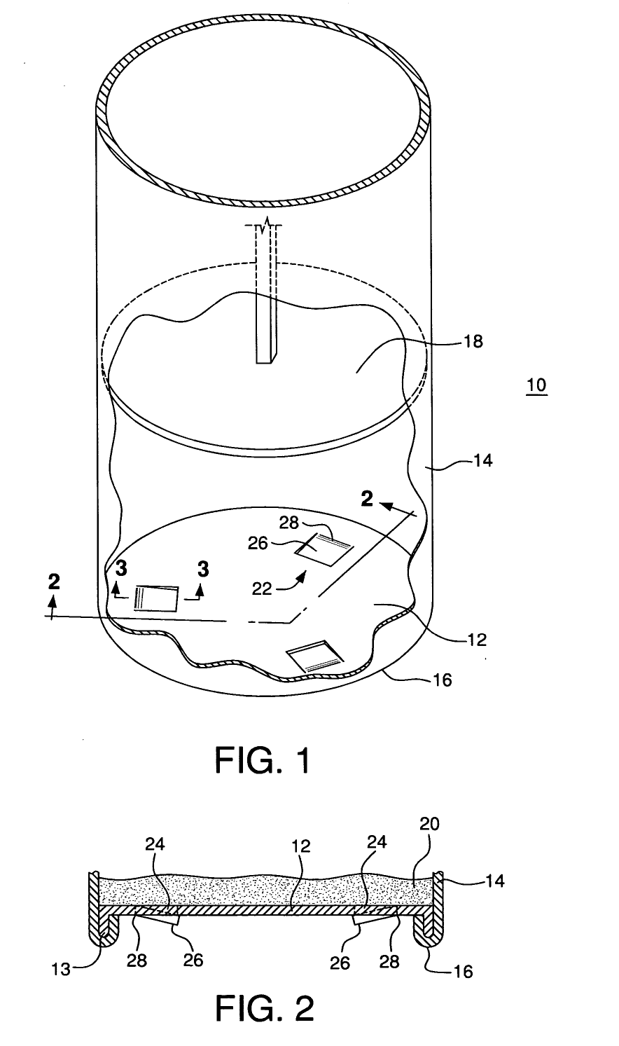

With reference to the drawings, where like numerals identify like elements, there is shown in FIG. 1 a container 10 in accordance with an embodiment of the present invention.

Container 10 comprises an end cap 12 attached to a container body 14. As used herein, “attached to” means “secured to,” “coupled with,” “engaged with,” “integral with,” or some other similar attachment means. As illustrated, container 10 further comprises a plunger 18 for use in exerting pressure on a liquid media 20.

Container 10 can house fluids, slurries, other flowable media and the like. Preferably, container 10 is used to house liquid food products such as condiments (e.g., ketchup, mustard, mayonnaise, and the like), sauces (barbecue sauce, tomato sauce, and the like), and dressings (e.g., salad dressing). While liquid food products are the preferred liquid media, it will be appreciated that the teachings herein are applicable to any liquid media container that dispenses a liquid or slurried product, e.g., ketchup, caulking, adhesives, toothpaste, and the like.

Container 10 can be a rigid container, a flexible package, a squeezable pouch, or some other container capable of housing fluids, slurries, and the like.

While container 10 is shown to include a cylindrical container body 14, a circular end cap 12, and a circular plunger 18, this combination is merely illustrative. For example, the container body can have a variety of cross-sectional shapes (including square, ellipse, polygon), provided that the end cap and the pressurizing device (if included) have a complimentary shape.

FIG. 2 illustrates an engagement of end cap 12 and container body 14. As illustrated, end cap 12 comprises a rim 13 that extends outwardly, preferably along the outer periphery of end cap 12. Rim 13 engages a “J” shaped edge 16 of container body 14 such that the engagement provides a fluid tight seal. The sealing can be accomplished by means of an adhesive, heat seal, or by some other similar means.

Alternatively, the end cap can be integral with the container body i.e., the container body and the end cap are in fact one piece. In such an embodiment, the integral fabrication of end cap 12 with container body 14 provides the fluid tight seal such that rim 13 and J-shaped orientation of edge 16 are not necessary.

End cap 12 comprises at least one valve orifice 22. The at least one valve orifice comprises a cut-out 24 and a flap or tab 26. Although cut-out 24 is shown as a square, the invention is not so limited. Cut-outs of the invention can be in the shape of a circle, a rectangle, a hexagon, an octagon, or any other geometric or non-geometric shapes.

As illustrated, end cap 12 comprises three valve orifices 22 spaced equally apart (i.e., at 120-degree intervals from one another). It is contemplated that less than three valve orifices can be used and that more than three valve orifices can be used on an end cap of the invention. It is also contemplated that the valve orifices do not have to be equally spaced from one another.

Flap 26 comprises a preloaded hinge attached to end cap 12. As illustrated, preloaded hinge 28 is integrally formed with end cap 12 at an outboard edge of flap 26. Alternatively, the preloaded hinge 28 can be engaged with, and not integral with, end cap 12. Also alternatively, hinge 28 can be attached to end cap 12 at a location other than the outboard edge of flap 26, e.g., hinge 28 can be located away from the edges or in the middle of flap 26.

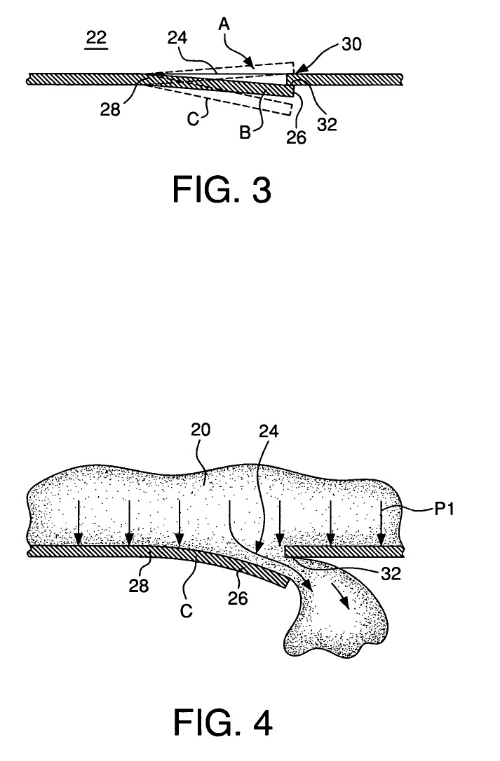

As shown in FIG. 3, end cap 12 is fabricated such that flap 26 is in position A i.e., molded above the seated plane. As illustrated, when flap 26 is in position A it contacts inside edge 30. However, it is contemplated that flap 26 can be in position A and yet not contact edge 30. Rather, it can be configured such that it is biased farther into container body 14. Increased biasing into container body 14 increases the preload potential of hinge 28.

To preload hinge 28, flap 26 is pressed or fit through cut-out 24 and released. Once released, hinge 28 acts as a spring causing flap 26 to engage outside edge 32 such that flap 26 is in first position B. A low modulus of elasticity (i.e., high flexibility) for the material making up flap 26 enables the spring to be formed about hinge 28. With the flexible material, flap 26 can rotate about hinge 28 so as to move from position A to first position B. However, the modulus of elasticity can not be too low, otherwise flap 26 would permanently deform preventing a snap-back hinge action. The strength of hinge 28 preferably is greater than the forces created by the static weight of a liquid material when that material substantially encompasses the entire container. That is, flap 26 should remain in first position B when container 10 is fully loaded with liquid media 20.

In FIG. 4, a first pressure (denoted by vertical arrows P1) is developed inside container body 14 by plunger 18. While a plunger is the preferred means to exert pressure onto the liquid media, it will be appreciated that other means of exerting pressure can be used. For example, container body 14 can comprise a squeezable pouch such as a traditional toothpaste dispenser or other similar container. With such an embodiment, the requisite pressure P1 is exerted by squeezing the exterior of the container, forcing liquid media 20 against flap 26.

As illustrated, pressure P1, exerted over the flap area, overcomes the preloaded spring force of hinge 28 so that flap 26 rotates about hinge 28 and moves from first position B to second position C. This movement allows liquid media 20 to flow through cut-out 24. When plunger 18 stops acting on liquid media 20 the pressure is reduced. As the pressure reduces, flap 26 rotates back toward first position B. When the pressure reduces below the preloaded spring force of hinge 28, flap 26 contacts edge 32 (i.e., completely returns to first position B) and the flow of liquid media 20 through cut-out 24 ceases. Consequently, flap 26 is entirely responsive, i.e., opens and shuts, to the pressure P1 developed inside container 10. In essence, flap 26 and hinge 28 act as a preloaded check valve to control flow of liquid media 20 in response to pressure variations in container body 14.

Because the purpose of flap 26 is to block flow of liquid media 20, the shape of flap 26 should substantially correspond to the shape of cut-out 24 such that it blocks flow. For example, if cut-out 24 is substantially square-shaped, then flap 26 can be a slightly larger square, a rectangle, or any other geometric or non-geometric figure that contacts outside edge 32 and prevents flow of liquid media 20 when in first position B. As used herein, substantially square includes shapes that have rounded corners, shapes with four sides that are not exactly equal in length, shapes that have corners that do not form perfect 90-degree angles, and so on.

If the shape of flap 26 is non-polygonal (i.e., not a square, rectangle, etc.) then hinge 28 can be linear or non-linear. For example, a flap that is substantially circular can have a hinge that corresponds to the radius of the circle or alternatively, the flap can have one linear edge corresponding to the location of the hinge with the remainder of the flap substantially forming a circle.

The container body and the end cap can be made from the same material. For example, both the container body and the end cap can be made from a plastic or thermoplastic material such as polyethylene (e.g., high density polyethylene, low density polyethylene), polypropylene, and the like. Alternatively, the container body and the end cap can be made from different materials. For example, the container body can be made from a paper product such as layered cardboard and the end cap can be made from a plastic or thermoplastic material.

Materials for the container body and the end cap should be selected based on factors such as the end use of the liquid media to be stored in the container. For example, for liquid food products, the container body and the end cap preferably are constructed of inert materials so that the food products are not contaminated by the material of the container body and the end cap. Beyond sanitary concerns, the weight of the liquid material is also a factor in selecting the material for the end cap and/or flap. As the weight of the liquid media increases, so to should the modulus of elasticity of the material used for, at a minimum, the flap. The increased weight of the liquid media could cause the flap to displace from the first position (and thus allow liquid media to flow through the cut-out) if the material is not properly selected.

The desired rigidity of the container is another factor to be considered in selecting the material for the container body and the end cap. If the liquid media is to be dispensed by means of external forces on the container body (e.g., squeezable pouches), the material used for the container body must be capable of deforming without losing its fluid retention properties. In such an embodiment the end cap can also be deformable or it can be rigid.

The viscosity of the liquid media is a factor to be considered in selecting the material for the flap and/or end cap. The greater the viscosity of the liquid media, the greater the amount of pressure required to dispense the liquid media. Consequently, as the viscosity of the liquid media increases, so to should the modulus of elasticity of the material used.

It will be appreciated by those skilled in the art, that the present invention may be practiced in various alternate forms and configurations. The previously detailed description of the disclosed embodiments are presented for purposes of clarity of understanding only, and no unnecessary limitations should be implied there from.

1. A container for storing and dispensing a liquid, slurry or other flowable media, comprising:
a container body for storing the media;
an end cap attached to the container body, the end cap having a first side and an opposing second side, the first side contacting the media; and
at least one valve orifice disposed through the end cap, the at least one valve orifice comprising a cut-out in the end cap and a flap attached to the end cap;
the flap comprising a preloaded hinge, the hinge causing the flap, when in a first position, to normally resiliently contact the opposing second side adjacent an edge of the orifice cut-out; and
when pressure is exerted on the media, the flap is displaced away from the edge of the orifice and the opposing second side to a second position enabling flow of the media through the cut-out, and the flap returning to the first position when exertion of pressure ceases.

2. The container of claim 1 wherein the container body comprises a flexible material.

3. The container of claim 2 wherein the container body is a squeezable pouch.

4. The container of claim 1 wherein the end cap is engaged with the container body.

5. The container of claim 4 wherein the end cap is heat sealed with the container body.

6. The container of claim 1 wherein the end cap further comprises a rim extending outwardly along an outer periphery of the second side, wherein the rim engages a J-shaped edge of the container body.

7. The container of claim 1 wherein the flap is integrally formed with the end cap.

8. The container of claim 1 wherein the hinge is attached to the end cap.

9. (canceled)

10. The container of claim 1 wherein the hinge is positioned along an outboard edge of the flap.

11. The container of claim 1 wherein the end cap is round.

12. The container of claim 1 wherein the cut-out is substantially square.

13. The container of claim 1 wherein the container further comprises a means for exerting pressure on the liquid media.

14. The container of claim 13 wherein the means for exerting pressure on the liquid media comprises a plunger.

15. The container of claim 1 wherein the end cap comprises polyethylene.

16. The container of claim 15 wherein the end cap comprises high density polyethylene.

17. The combination of a container and an end cap, the end cap serving to control flow of a liquid media from the container, the end cap comprising:
at least one valve orifice comprising
a cut-out extending through the end cap, and
a tab integrally formed with the end cap, the tab comprising a shape substantially corresponding to the cut-out and a size larger than the cut-out, and
the tab further comprising a hinge integrally formed with the end cap, the hinge resiliently biasing the tab in a first position against an outer face of the end cap, adjacent an edge of the cut-out.

18. The end cap of claim 17 comprising means to attach the end cap to the container.

19. The end cap of claim 18 wherein the end cap is integrally formed with the container.

20. The end cap of claim 18 wherein pressure exerted on the liquid media in the container displaces the tab to a second position by resilient movement of the tab about the hinge, enabling flow of the liquid media through the orifice.

21. An end cap comprising:
a first surface and an opposing second surface, the second surface being an outer surface of the end cap;
three equally spaced valve orifices oriented on the end cap;
each valve orifice comprising a substantially square cut-out and a substantially square tab, and
the tab comprising a preloaded hinge integrally formed with the end cap, the hinge biasing the tab in a first position against the second surface, adjacent an edge of the cutout, and wherein, when pressure is exerted on at least one tab, the at least one tab displaces to a second position, away from the second surface.

22. An end cap for controlling flow of a liquid media in a container, the end cap comprising:
a first surface and an opposing second surface,
at least one valve orifice comprising a cut-out extending through the end cap and a tab,
the tab further comprising a resilient hinge joining the tab to the end cap, the hinge resiliently biasing the tab against the second surface, and the tab closing the cut-out when the tab is biased against the second surface.
